(19) United States
(12) Patent Application Publication
(10) Pub. No.: US 2016/0141623 A1
(43) Pub. Date: May 19, 2016

(54) BIPOLAR ELECTRODE, BIPOLAR ALL-SOLID BATTERY MANUFACTURED BY USING THE SAME, AND MANUFACTURING METHOD THEREOF

(71) Applicant: Hyundai Motor Company, Seoul (KR)

(72) Inventors: Yong Sub Yoon, Seoul (KR); Sang Heon Lee, Yongin (KR); Byung Jo Jeong, Seoul (KR); Hong Seok Min, Yongin (KR)

(21) Appl. No.: 14/737,793

(22) Filed: Jun. 12, 2015

(30) Foreign Application Priority Data
Nov. 14, 2014 (KR) 10-2014-0158998

(51) Int. Cl. H01M 4/62; H01M 4/04; H01M 4/66

(52) U.S. Cl. CPC H01M 4/62; H01M 4/661; H01M 4/625; H01M 4/0402; H01M 4/043; H01M 2004/029

(57) ABSTRACT

Disclsoed are a bipolar electrode, a bipolar all-solid battery manufactured by using the same, and a manufacturing method thereof. The bipolar electrode includes: a solid electrolyte; an anode slurry and a cathode slurry, each of which is provided on a first surface and a second surface of the solid electrolyte; spacers provided in the anode slurry and the cathode slurry; and a metal substrate provided in the anode slurry and the cathode slurry. Accordingly, an output and an energy density may be improved by cell integration through minimization of thickness of the cathode, the anode, and the electrolyte of the all-solid battery. Further, when the bipolar all-solid battery is manufactured using high voltage stability characteristic of the solid electrolyte, difference in an elongation rate or a compression rate among the elements may be reduced to secure or improve process stability and to minimize a cell defective rate.

### CROSS-REFERENCE TO RELATED APPLICATION

This application is based on and claims the benefit of priority to Korean Patent Application No. 10-2014-0158998, filed on Nov. 14, 2014 in the Korean Intellectual Property Office, the disclosure of which is incorporated herein in its entirety by reference.

### TECHNICAL FIELD

The present invention relates to a bipolar electrode, a bipolar all-solid battery manufactured by using the same, and a manufacturing method thereof. In particular, by applying spacers to a bipolar electrode, mechanical physical properties of a cathode, an anode, and an electrolyte which are elements of an all-solid battery may be secured and easy manufacturing processes can be designed.

### BACKGROUND

In general, an all-solid battery includes a solid electrolyte that replaces an organic electrolyte, and thus, has received attention as a next generation battery that may overcome safety problems.

In the related arts, the conventional bipolar all-solid battery includes electrode plates coated as a cathode/an anode that are stacked on both surfaces of a current collector, respectively, with the purpose of stacking in series for achieving a high voltage. Thus, a cell assembly is manufactured by preparing one sheet of bipolar electrode in a form in which three elements such as the cathode, the anode, and the electrolyte are stacked on the current collector; stacking several to tens of the bipolar electrode sheets in series to prepare a laminate; compressing the laminate at a high temperature/a high pressure to highly densify each element and to make an interlayer contact compact so as to minimize interfacial contact resistance; and performing a pouch and a tab welding process on the compressed all-solid battery laminate.

However, such conventional bipolar all-solid battery may have disadvantages in that difference in physical properties such as each mixture density, an elongation rate, and the like may not be reduced, since the same pressure condition is applied to each stacked element (cathode/anode/electrolyte), and elongation modification in the electrolyte significantly occurs due to soft surface characteristic according to material specification. As consequence, an inner short-circuit between the cathode and the anode may be caused.

The matters described as the related art have been provided only for assisting in the understanding for the background of the present invention and should not be considered as corresponding to the related art known to those skilled in the art.

### SUMMARY

In preferred aspects, the present invention provides a bipolar electrode, bipolar all-solid battery manufactured with the bipolar electrode, and a method of manufacturing the same to address the above-mentioned problems in the related arts.

In one aspect, provided is a bipolar electrode capable of easily securing or improving mechanical physical properties of a cathode, an anode, and an electrolyte of an all-solid battery and easily designing processes by applying spacers

According to an exemplary embodiment of the present invention, a bipolar electrode includes: a solid electrolyte; an anode slurry and a cathode slurry, each of which may be provided on a first surface and a second surface of the solid electrolyte, respectively; spacers provided in the anode slurry and the cathode slurry; and a metal substrate provided on the anode slurry and the cathode slurry. The spacers, as used herein, may be in a substantially spherical shape such as a ball, however the shape thereof may not be limited thereto.

The spacers may be patterning-coated on the first and the second surfaces of the solid electrolyte at predetermined intervals.

The spacer may be made of a ceramic or metal material.

The spacers may be made of a metal oxide-based material selected from the group consisting of aluminum oxide (Al₂O₃), zirconium oxide (ZrO₂), zinc oxide (ZnO₂), and magnesium oxide (MgO).

The anode slurry may comprise anode active material powders, electrolyte powders, carbon conductive powders, and a binder, and a weight ratio of the anode active material powders, the electrolyte powders, the carbon conductive powders, and the binder may be of about 70:30:5:5.

The cathode slurry may comprise cathode active material powders, electrolyte powders, carbon conductive powders, and a binder, and a weight ratio of the cathode active material powders, the electrolyte powders, the carbon conductive powders, and the binder may be of about 70:30:5:5.

In another aspect of the present invention, provided is a bipolar all-solid battery manufactured by stacking the bipolar electrodes as described above and pressurizing and compressing the stacked bipolar electrodes by press equipment.

According to an exemplary embodiment of the present invention, a manufacturing method of a bipolar electrode may include: preparing a spacer slurry including spacers; adding the spacer slurry to an anode slurry; adding the spacer slurry to a cathode slurry; preparing an electrolyte slurry; and a fifth step of stacking the anode slurry and the cathode slurry each including the spacers on a first side and a second side of the electrolyte slurry, respectively.

The manufacturing method may further include: forming a bipolar all-solid battery by drying and pressing electrode plates at the time of stacking the anode slurry and the cathode slurry on the electrolyte slurry.

Futher provided is a bipolar all-solid battery manufactured by stacking a plurality of bipolar electrodes as described herein, and pressurizing and compressing the stacked bipolar electrodes by press equipment.

Other aspects of the invention are disclosed infra.

### BRIEF DESCRIPTION OF THE DRAWINGS

The above and other objects, features and advantages of the present invention will be more apparent from the following detailed description taken in conjunction with the accompanying drawings.

FIG. 1 illustrates an exemplary bipolar electrode according to an exemplary embodiment of the present invention.

FIG. 2 illustrates an exemplary bipolar all-solid battery manufactured by using an exemplary bipolar electrode according to an exemplary embodiment of the present invention.

FIGS. 3A-3C illustrate exemplary embodiments of patterning of spacers in exemplary bipolar electrodes of the present invention.

FIG. 4 is a flow chart illustrating an exemplary manufacturing method of an exemplary bipolar electrode according to an exemplary embodiment of the present invention.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention will be described in detail below with reference to the accompanying drawings.

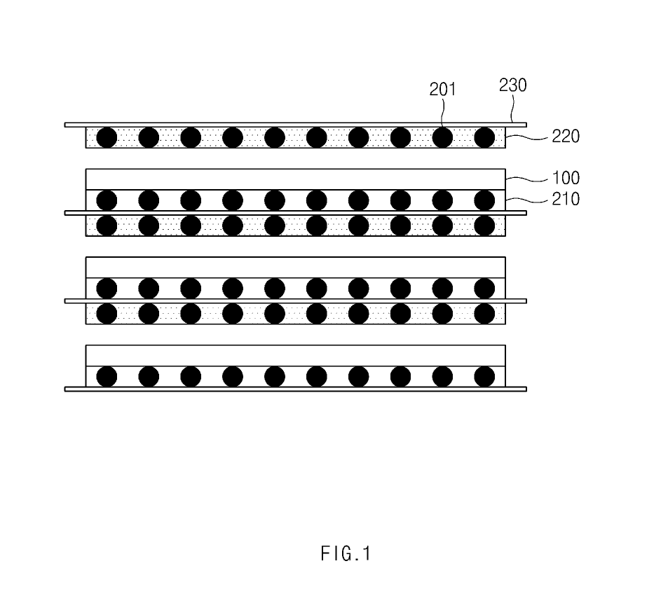

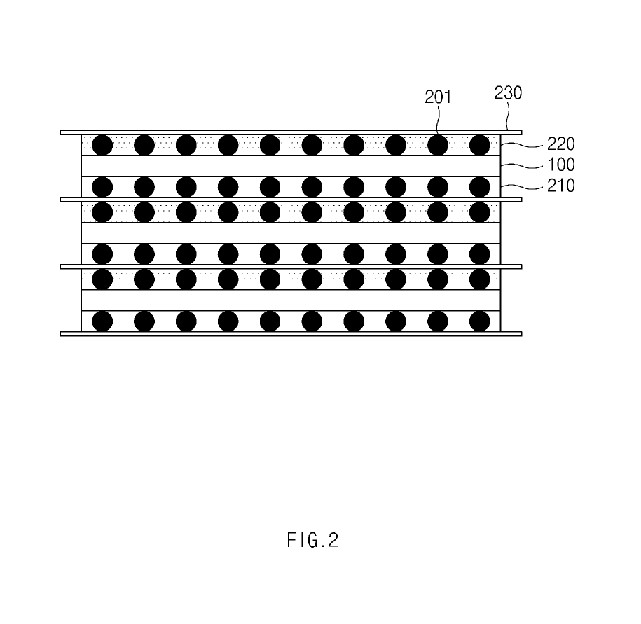

As shown in FIGS. 1 and 2, provided is an exemplary bipolar electrode of the present invention and an exemplary bipolar all-solid battery manufactured by using the same. Particularly, the bipolar electrode may include: a solid electrolyte 100, spacers 201 provided in an anode slurry 210 and a cathode slurry 220; and a metal substrate 230 provided in the anode slurry 210 and the cathode slurry 220.

Each of the anode slurry 210 and the cathode slurry 220 may be provided, respectively, on a first surface or a second surface of the solid electrolyte 100.

The solid electrolyte 100 may be an inorganic solid electrolyte, and may be made of crystalline or amorphous materials, or oxide-based or sulfide-based materials, for example, Li₃N, a lithium super ionic conductor (LISICON), LIPON(Li³⁺₃PO₄₋ₓNₓ), Thio-LISICON(Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li₂O—Al₂O₃—TiO₂—P₂O₅(LATP), and the like.

In addition, the cathode slurry 220 may be prepared by sufficiently mixing LiCoO₂ cathode active material powders, electrolyte powders as described above, carbon conductive powders, and a binder for bonding in electrodes. An exemplary composition ratio of the LiCoO₂ cathode active material powders, the electrolyte powders, the carbon conductive powders, and the binder may be of about 70:30:5:5 to manufacture an exemplary cathode composite, but the composition ration may vary without limitation to optimally obtain the cathode composite generally used in the art. As used herein, the binder may be, but not limited to, selected from the group consisting of Super P in a powder type, Denka in a rod type, and VGCF in a rod type, or alternatively, the binder may be selected from the group consisting of polymer compounds of a fluorine-based polymer, a diene-based polymer, an acrylic polymer, and a silicone-based polymer.

The composite materials may be added to an organic solvent and mixed for a predetermined time to obtain an uniformly dispersed slurry. For a coating process, the solid content of the slurry may be adjusted to have a viscosity of about 800 to 1200 cPs. Exemplary the organic solvent may include cyclic aliphatic hydrocarbons such as cyclopentane, cyclohexane, and the like, or aromatic hydrocarbons such as toluene, xylene, and the like, and these solvents may be used alone or a mixture of at least two or more thereof may be used in consideration of a drying rate or environment. For example, when the sulfide-based electrolyte is used in the present invention, a non-polar aromatic hydrocarbon-based solvent may be used suitably in view of chemical reactivity.

In addition, the anode slurry 210 may be prepared by sufficiently mixing anode active material powders, electrolyte powders, carbon conductive powders, and a binder for bonding in electrodes. An exemplary composition ratio of the anode active material powders, the electrolyte powders, the carbon conductive powders, and the binder may be of about 70:30:5:5 but the composition ration may vary without limitation to optimally obtain the anode composite generally used in the art. The anode active material may be prepared by using natural graphite, artificial graphite, soft carbon and hard carbon, and a process for preparing the anode slurry described above for mixing process of the cathode slurry may be used without limitation.

In addition, the electrolyte slurry may be prepared by mixing the solid electrolyte and the binder at a ratio of about 95:5 and performing the same process of the preparation of the electrode slurry described above. For instance, mixing process conditions for the electrolyte slurry may be similar to preparation conditions for the electrode slurry.

The spacers 201 may be provided in the anode slurry 210 and the cathode slurry 220, such that mechanical physical properties of the cathode, the anode, and the electrolyte which are elements of the all-solid battery may be easily secured and design of processes may be easily performed.

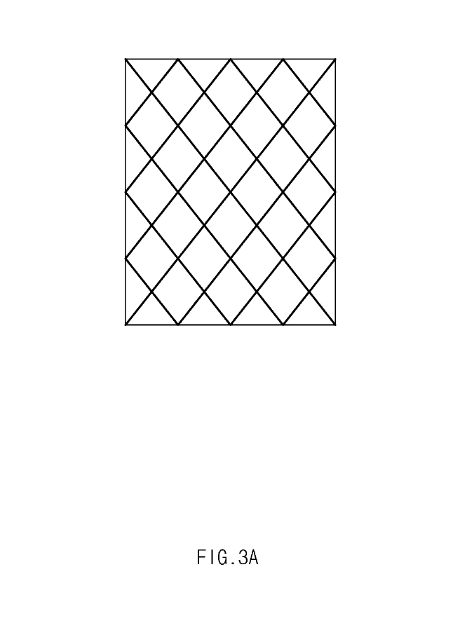

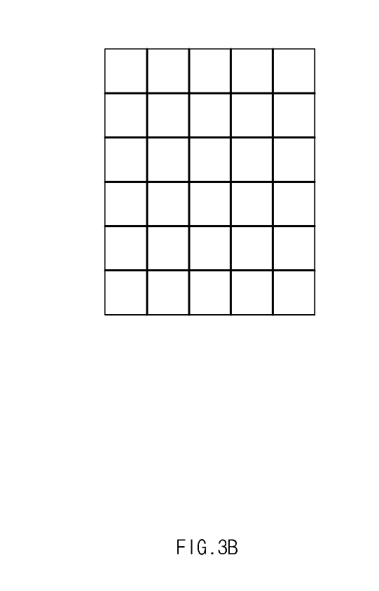

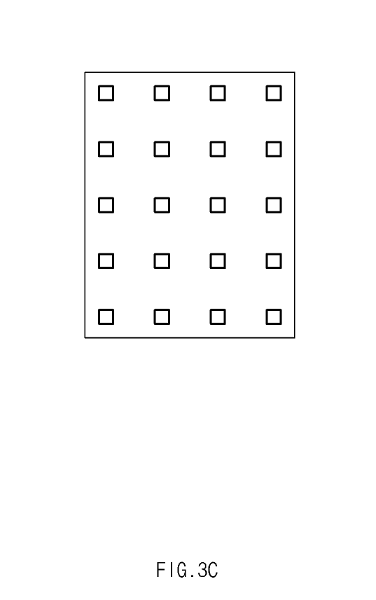

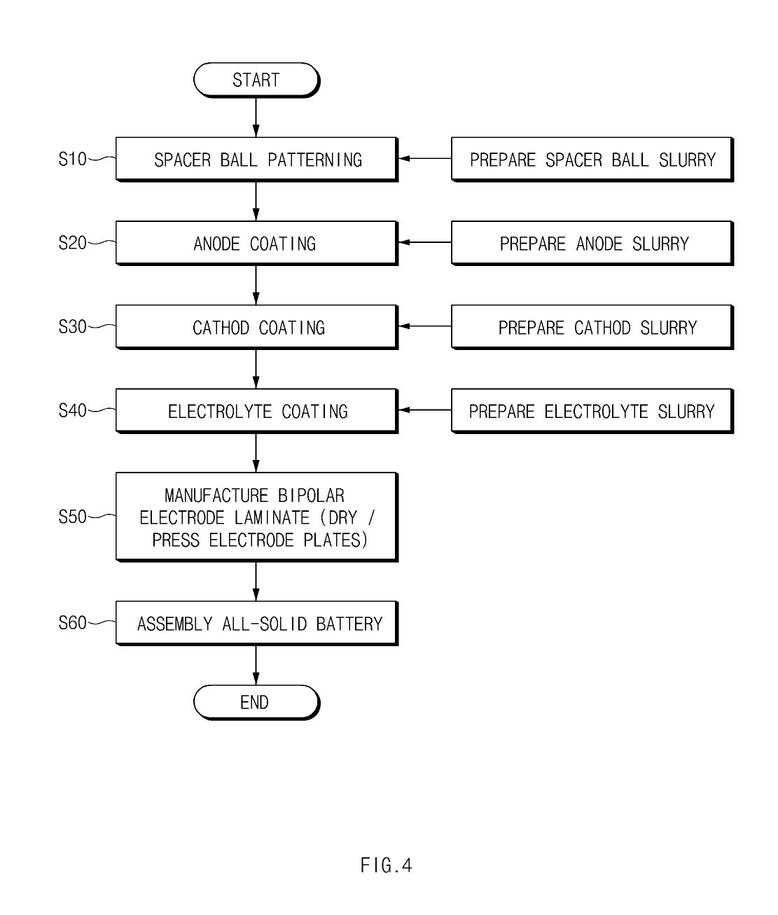

As a current collecting substrate to which the slurry may be coated, a nickel foil having a predetermined thickness, for example, of about 15 μm, may be used, and as shown in FIG. 3, patterns may be formed by printing which is appropriate for a roll-to-roll process according to an exemplary embodiment of the present invention. Among the methods, a gravure coating method may be used.

The gravure coating method is one of an intaglio transfer printing method, and patterns may be transferred by coating an ink onto a surface of a cylinder in which patterns are formed, removing the ink coated onto a convex surface, and contacting the ink present in a concave portion to a surface of a material which is printed.

In addition, an alumina slurry may be used as a material for patterning, and a nickel metal substrate in which alumina is finally patterned may be prepared by printing the alumina slurry on both surfaces of the substrate by gravure coating at uniform intervals and positions.

The metal substrate 230 may be provided in the anode slurry 210 and the cathode slurry 220.

Further, the present invention relates to a bipolar electrode including the anode slurry 210 and the cathode slurry 220, each of which may be provided on a first surface and a second surface of the solid electrolyte 100, respectively; and the spacers 201 and the metal substrate 230 provided in the anode slurry 210 and the cathode slurry 220. The bipolar all-solid battery may be manufactured by stacking the bipolar electrodes and pressurizing and compressing the stacked bipolar electrodes by a press equipment.

As described above, the spacers of the bipolar all-solid battery described in the present invention may be made of ceramic or metal materials to secure or improve mechanical physical properties. Alternatively, as the spacer, metal oxide-based materials capable of forming uniform particle size and having relatively low cost may be used and the examples thereof may include aluminum oxide (Al₂O₃), zirconium oxide (ZrO₂), zinc oxide (ZnO₂), magnesium oxide (MgO), and the like. In addition, other chemically stable materials may also be applied as generally used in the related arts.

As described above, the application of the ceramic-based spacer 201 may contribute to achieve high efficiency in designing the all-solid battery structure.

A manufacturing method of the bipolar electrode according to the present invention may include: preparing a spacer slurry (S10); preparing an anode slurry 210 (S20); preparing a cathode slurry 220 (S30); preparing an electrolyte slurry (S40); forming a bipolar electrode by stacking (S50).

In the step of S10, the spacer slurry including spacers 201 may be prepared. In the step of S20, the anode coating may be formed by adding the spacer slurry to the anode slurry 210.

In the step of S30, a cathode coating may be formed by adding the spacer slurry to the cathode slurry 220.

In the step of S40, the electrolyte slurry may be prepared.

In the fifth step S50, the anode slurry 210 and the cathode slurry 220, each of which may contain the spacers 201 formed therein, may be stacked on each side the electrolyte slurry, respectively.

In addition, the manufacturing method may further include: forming a bipolar all-solid battery by drying and pressing electrode plates at the time of stacking the anode slurry 210 and the cathode slurry 220 on the electrolyte slurry S60. As described above, according to the bipolar electrode, the bipolar all-solid battery manufactured by using the same, and the manufacturing method thereof, the spacers 201 may be applied for securing or improving mechanical physical properties of the cathode, the anode, and the electrolyte which are elements of the all-solid battery and processes can be easily designed. In particular, before coating the cathode slurry or the anode slurry onto both surfaces of the current collector, the spacers 201 may be previously patterning-coated at predetermined intervals and then the cathode or anode slurry may be coated. Further, a coating thickness may be determined in consideration of volume reduction by press equipment at the time of stacking in the cell later, a particle size of the spacer 201 may be controlled according to the designed thickness. Then, the stacking coating may be performed on one side surface or both surfaces of the cathode or the anode plate obtained by applying and drying the solid electrolyte slurry to thereby complete manufacture of the bipolar electrode. Moreover, the bipolar electrode may be manufactured to be included in a high voltage all-solid battery by performing a stamping process at predetermined intervals according to cell specification, stacking the electrode plates in series, and performing a hot press process at high pressure/high temperature.

The convention electrode has been manufactured in a thick thickness having several hundreds of microns or more due to problems of cell damage, short-circuit, and the like, caused by difference in physical properties among the elements. However, with the bipolar electrode according to various exemplary embodiments of the present invention, since the spacers 201 are applied in the cathode, the anode, and the electrolyte of all-solid battery, the difference in interlayer physical properties may be reduced by applying the spacers 201 and thus, cells may be stably manufactured by having the minimum particle size of the spacer 201 and a thickness of several tens of microns or less, thereby obtaining the degree of freedom in designing.

As described above, according to the exemplary embodiments of the present invention as described above, an output and an energy density may be improved by cell integration through minimization of thickness of the cathode, the anode, and the electrolyte which are elements of the all-solid battery, and as the bipolar all-solid battery is manufactured using the solid electrolyte with high voltage stability characteristics, difference in an elongation rate or a compression rate among the elements may be reduced to secure process stability and to minimize a cell defective rate.

In addition, performance may be improved by achieving high voltage through the all-solid battery having a large area or stacked in series, and by adopting miniaturization/mass production processes of products, process capability and cost competitiveness may be improved and products utilization may be expanded. Further, integration of the all-solid battery cell may be achieved to improve an output and an energy density at the time of manufacturing the cell. In addition, since mechanical physical properties may be secured or improved, additional protecting apparatuses and structural design may not be separately required, and shapes and performance of the products may be easily designed by simply changing disposition and stacking structures of the same small cells.

Although the present invention has been described with reference to exemplary embodiments and the accompanying drawings, it would be appreciated by those skilled in the art that the present invention is not limited thereto but various modifications and alterations might be made without departing from the idea of the present invention and the scope defined in the claims.

What is claimed is:

1. A bipolar electrode comprising:
a solid electrolyte;
an anode slurry and a cathode slurry, each of which is provided on a first surface and a second surface of the solid electrolyte, respectively;
spacers provided in the anode slurry and the cathode slurry; and
a metal substrate provided on the anode slurry and the cathode slurry.

2. The bipolar electrode according to claim 1, wherein the spacers are patterning-coated on the first and the second surfaces of the solid electrolyte at predetermined intervals.

3. The bipolar electrode according to claim 1, wherein the spacers have a shape of a ball.

4. The bipolar electrode according to claim 1, wherein the spacers are made of a ceramic or metal material.

5. The bipolar electrode according to claim 1, wherein the anode slurry comprises anode active material powders, electrolyte powders, carbon conductive powders, and a binder, and a weight ratio of the anode active material powders, the electrolyte powders, the carbon conductive powders, and the binder is of about 70:30:5:5.

6. The bipolar electrode according to claim 1, wherein the cathode slurry comprises cathode active material powders, electrolyte powders, carbon conductive powders, and a binder, and a weight ratio of the cathode active material powders, the electrolyte powders, the carbon conductive powders, and the binder is of about 70:30:5:5.

7. The bipolar electrode according to claim 1, wherein the space ball is made of a metal oxide-based material selected from the group consisting of aluminum oxide (Al₂O₃), zirconium oxide (ZrO₂), zinc oxide (ZnO₂), and magnesium oxide (MgO).

8. A bipolar all-solid battery manufactured by stacking a plurality of bipolar electrodes of claim 1, and pressurizing and compressing the stacked bipolar electrodes by press equipment.

9. A manufacturing method of a bipolar electrode, comprising:
preparing a spacer slurry including spacers;
adding the spacer slurry to an anode slurry;
adding the spacer slurry to a cathode slurry;
preparing an electrolyte slurry; and
stacking the anode slurry and the cathode slurry each including the spacers on a first side and a second side of the electrolyte slurry, respectively.

10. The manufacturing method according to claim 9, further comprising:
forming a bipolar all-solid battery by drying and pressing electrode plates at the time of stacking the anode slurry and the cathode slurry on the electrolyte slurry.

11. The method according to claim 9, wherein the spacer is made of a ceramic or metal material.

12. The method according to claim 9, wherein the anode slurry comprises anode active material powders, electrolyte powders, carbon conductive powders, and a binder, and a weight ratio of the anode active material powders, the electrolyte powders, the carbon conductive powders, and the binder is of about 70:30:5:5.

13. The method according to claim 9, wherein the cathode slurry comprises cathode active material powders, electrolyte powders, carbon conductive powders, and a binder, and a weight ratio of the cathode active material powders, the electrolyte powders, the carbon conductive powders, and the binder is of about 70:30:5:5.

14. The method according to claim 9, wherein the space ball is made of a metal oxide-based material selected from the group consisting of aluminum oxide (Al₂O₃), zirconium oxide (ZrO₂), zinc oxide (ZnO₂), and magnesium oxide (MgO).
